(19) United States
(12) Patent Application Publication
(10) Pub. No.: US 2005/0080999 A1
(43) Pub. Date: Apr. 14, 2005

(54) Memory interface for systems with multiple processors and one memory system

(76) Inventors: Fredrik Angsmark, Lund (SE); Tord Nilsson, Lund (SE); David Barrow, Durham, NC (US)

Correspondence Address: JENKENS & GILCHRIST, PC, 1445 ROSS AVENUE, SUITE 3200, DALLAS, TX, 75202, US

(21) Appl. No.: 10/857,319

(22) Filed: May 27, 2004

Related U.S. Application Data
(60) Provisional application No. 60/509,503, filed on Oct. 8, 2003.
(60) Provisional application No. 60/510,074, filed on Oct. 9, 2003.
(60) Provisional application No. 60/530,960, filed on Dec. 19, 2003.

(51) Int. Cl. G06F 12/00

(52) U.S. Cl. 711/150; 711/151

(57) ABSTRACT

Memory interface for multi-CPU system provides predefined time slots in which each CPU may access an external memory. The time slot assigned to each CPU may be defined according to the expected memory requirements of the CPU. In this way, each CPU is guaranteed to have a certain amount of dedicated bandwidth to the external memory. The predefined time slots also allow the latency of the system to be known, which is useful for real-time oriented applications. Moreover, each CPU may use its own clock during its allotted time slot to control the external memory, thus accommodating various clock domains in the system. Memory refresh and data protection functions are also provided. This Abstract is provided to comply with rules requiring an Abstract that allows a searcher or other reader to quickly ascertain subject matter of the technical disclosure. This Abstract is submitted with the understanding that it will not be used to interpret or limit the scope or meaning of the claims.

### CROSS REFERENCE TO RELATED APPLICATIONS

This Application claims priority from, and hereby incorporates by reference, U.S. Provisional Application Nos. 60/509,503, filed Oct. 8, 2003; 60/510,074, filed Oct. 9, 2003; and 60/530,960, filed Dec. 19, 2003, all bearing the title “High Performance and Reliability Memory Interface for Systems with Multiple CPUs and One Memory.”

### BACKGROUND

1. Technical Field

The present invention relates to memory systems and, in particular, to an interface for a memory system that is accessible by multiple processors.

2. History of Related Art

A control processor (CPU) requires memory in order to operate. The memory may be on the same integrated circuit or “chip” with the CPU, as in the case of a digital application specific integrated circuit (ASIC), or it may be located externally. On-chip memory has the advantage of being faster than external memory, but is more expensive and not very scalable. Thus, the amount of on-chip memory in most digital ASICs is relatively small. External memory, on the other hand, costs less and is scalable. Therefore, a relatively large amount of external memory is usually provided in addition to any on-chip memory that may be present. A communication bus facilitates data transfer to and from the CPU and the external memory. The communication bus is typically controlled by an external memory interface that regulates access to the communication bus.

In some systems, there may be more than one CPU, with each CPU requiring access to memory. To keep the total system cost down for such systems, the CPUs may need to share the same external memory. For example, in certain systems, the control processor and a direct memory access controller access the same external memory. Since only one CPU may control the external memory at a time, a number of challenges are placed on the design of the memory interface. In particular, the memory interface needs to be able to give each CPU a certain minimum required bandwidth to the external memory. The memory interface also needs to be able to handle simultaneous access to the external memory. Other challenges include refreshing the memory (i.e., which CPU will perform the refresh), preventing one CPU from modifying another CPU's data, determining the wait time or latency for each CPU, and the like.

Existing memory interfaces use an asynchronous request-and-grant system to handle multiple CPUs. Typically, when one CPU needs to access the external memory, that CPU sends a memory access request signal to the memory interface. The memory interface sends a reply signal back to the CPU acknowledging that the request has been received. The memory interface then decides whether the request may be granted based on some predefined scheme. The scheme may be, for example, a first-in-first-out scheme, a priority-based scheme, a random access scheme, and the like. The memory interface thereafter sends a grant signal to the CPU, and its the CPU may reply by sending an acknowledgement signal back to the memory interface. The access to the external memory may then take place.

### SUMMARY OF THE INVENTION

A memory interface provides predefined time slots in which each of a plurality of CPUs may access the external memory. A time slot assigned to each CPU may be defined according to the expected memory requirements of the CPU. Each CPU is guaranteed to have a certain amount of dedicated bandwidth to the external memory. The predefined time slots allow the latency of the system to be known, which is useful for real-time oriented applications. Moreover, each CPU may use its own clock during its allotted time slot to control the external memory, thus accommodating various clock domains in the system. Memory refresh and data protection functions are also provided.

In general, in one aspect, the invention is directed to a method of granting access to a single external memory from multiple control processors. The method comprises the steps of defining a first time slot and a second time slot, granting access to the external memory to a first control processor during the first predefined time slot, and granting access to the external memory to a second control processor during the second predefined time slot.

In general, in one aspect, the invention is directed to a memory interface for allowing multiple control processors to access a single external memory. The memory interface comprises a first control processor, a second control processor, and an arbiter inter-operably connected to and synchronized with one of the first and second control processors. The arbiter is configured to grant access to the external memory to the first control processor during a first predefined time slot and grant access to the external memory to the second control processor during the second predefined time slot.

It should be emphasized that the term comprises/comprising, when used in this specification, is taken to specify the presence of stated features, integers, steps, or components, but does not preclude the presence or addition of one or more other features, integers, steps, components, or groups thereof.

### BRIEF DESCRIPTION OF THE DRAWINGS

The foregoing and other advantages of the invention will become apparent from the following Detailed Description and upon reference to the Drawings, wherein:

FIG. 1 illustrates a block diagram of an exemplary memory interface having a separate memory controller for each CPU; and

FIG. 2 illustrates a block diagram of another exemplary memory interface having a single memory controller for all CPUs.

### DESCRIPTION OF ILLUSTRATIVE EMBODIMENTS OF THE INVENTION

Following is a Detailed Description of Illustrative Embodiment(s) of the invention with reference to the drawings wherein the same reference labels are used for the same or similar elements. As used herein, the term “access”, when used in conjunction with the term “external memory”, means and refers to any memory operation, including, but not necessarily limited to, read operations, write operations, and refresh operations.

While asynchronous request-and-grant systems work reasonably well, improvements in several areas are desirable. For example, various handshakes that take place between the CPU and the memory interface can consume valuable bandwidth. In addition, it is difficult to predict the latency of the system with any accuracy for a given CPU because the memory access, once granted, is usually not interrupted until the CPU is finished. This unknown and potentially long wait time may cause problems for other CPUs, especially in real-time-oriented applications.

Therefore, a memory interface may use predefined time slots to grant external memory access to the CPUs. The time slot assigned to each CPU may be defined according to the expected memory needs of the CPU. In this way, each CPU is guaranteed to have a minimum amount of dedicated bandwidth to the external memory. Having predefined time slots also allows the latency of the system to be known, which is useful for real-time-oriented applications.

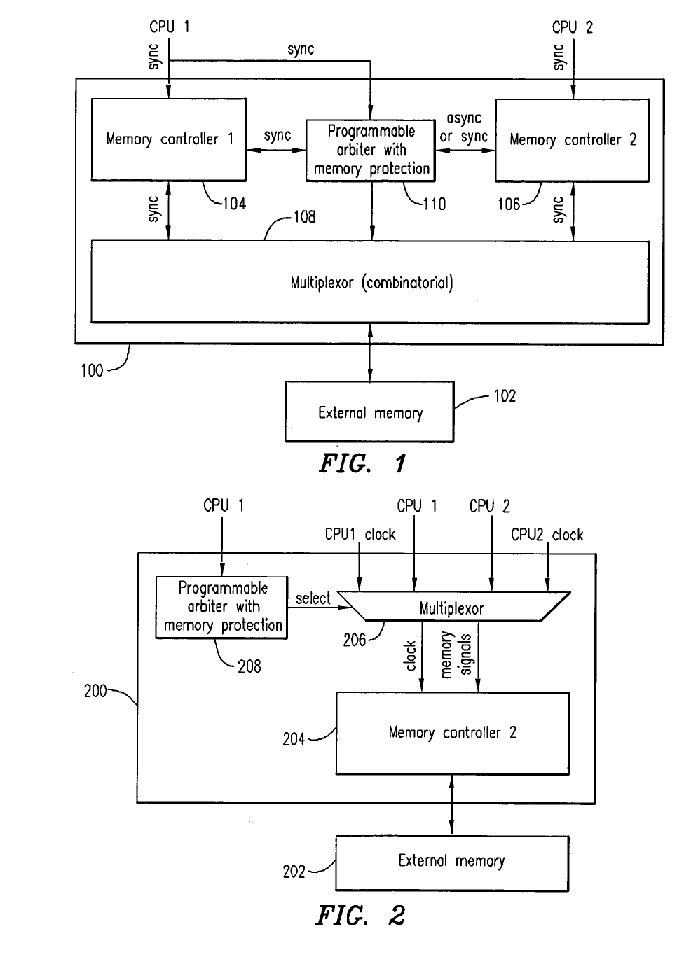

Referring now to FIG. 1, a block diagram illustrating a memory interface 100 is shown. The memory interface 100 connects a first CPU (CPU1) and a second CPU (CPU2) to a single external memory 102. Both CPU1 and CPU2 may reside on a single chip, as in the case of many digital ASICs, or CPU1 and CPU2 may reside on a separate chips. Where CPU1 and CPU2 reside on a single chip, the memory interface 100 may be located on the same chip as the CPUs, or the memory interface 100 may be located on a separate chip. CPU1 and CPU2 may perform the same functions, or each CPU may perform a different function (e.g., network access versus applications execution). In the latter case, CPU1 and CPU2 may have different clock frequencies, as well as different bandwidth requirements with respect to the external memory 102.

The memory interface 100 includes a separate memory controller for each of CPU1 and CPU2. Thus, in the example of FIG. 1, CPU1 is connected to one memory controller 104, while CPU2 is connected to another memory controller 106. The memory controllers 104 and 106 may be any suitable memory controller capable of providing appropriate control signals, including write-enable, read-enable, memory address, data, and the like, to the external memory 102. Each of the memory controllers 104 and 106 is connected to the external memory 102 via a multiplexer 108, which may be, for example, a combinatorial multiplexer.

An arbiter 110 is connected to the multiplexer 108. The arbiter 110 may be any suitable logic device and is configured to control which one of the memory controller 104 or 106 is multiplexed to the external memory 102 at any given time. Access to the external memory 102 is granted on a time slot basis where the memory controller 104 or the memory controller 106 is enabled for a specific amount of time. The length of the time slots may be predefined, for example, according to the external-memory requirements of the CPU, the clock frequency of the CPU, or some other factor. Each CPU thus has a certain minimal bandwidth and a certain maximum latency with respect to the external memory 102. The arbiter 110 may also be programmable, such that the length of the time slots may be adjusted from time to time as needed.

In operation, each of the memory controllers 104 and 106 is synchronized with CPU1 or CPU2. In other words, the memory controller 104 is synchronized with CPU1 and the memory controller 106 is synchronized with CPU2, such that each memory controller operates according to the clock frequency of its respective CPU. Thus, when a CPU (e.g., CPU1 or CPU2) is granted access to the external memory 102, there is a synchronous path from the CPU to the external memory 102 and back. In a similar way, the arbiter 110 is also synchronized with one of the CPUs (e.g., CPU1). Usually, the arbiter 110 is synchronized with the CPU with the fastest clock in order to achieve the highest time slot resolution. The arbiter 110 is also synchronized with the memory controller (e.g. memory controller 104) for that CPU, but not necessarily with the memory controller for the other CPU(s).

When either of CPU1 or CPU2 wishes to access the external memory 102, the accessing CPU simply provides the desired address(es) to the respective memory controller (i.e., the memory controller 104 or 106). If a write operation is involved, the accessing CPU also provides the data to be written to the external memory 102. In any case, no request-and-grant handshake needs to take place between the accessing CPU and the respective memory controller because the respective memory controller is dedicated to the accessing CPU. When the accessing CPU's time slot begins, the arbiter 110 sends an enabling signal to the respective memory controller and causes the multiplexer 108 to multiplex the control signals from that memory controller to the external memory 102. Typically, a “ready” or “data available” or “wait” signal is used to indicate when the current data transfer (data written or data read) is complete. This allows the CPU to access the data without having to know the exact latency. Thereafter, the memory operation proceeds as normal until the time slot expires, and the process is repeated in the next CPU's time slot.

To ensure that the data for each of CPU1 and CPU2 is protected, in some embodiments of the invention, the arbiter 110 may include registers (not expressly shown) that contain memory parameters for each of CPU1 and CPU2. The registers may define, for example, which areas of the external memory 102 are accessible by what CPU, and which areas of the external memory 102 are accessible by both CPUs. When a memory controller receives the desired address(es) from a CPU, the memory controller forwards the received address information to the arbiter 110. The arbiter 110 thereafter checks the address information against information stored in the registers of the arbiter 110 and determines whether the CPU has permission to access that area of the external memory 102. If yes, then the arbiter 110 allows the memory operation to proceed as normal. If no, the arbiter 110 disables the memory controller and an error condition is reported to the CPU.

In some embodiments of the invention, the arbiter 110 may also include a refresh function for the external memory 102. Such memory refresh functions are well known to persons having ordinary skill in the art and will not be described further. As another option, the refresh function may reside on one of the CPUs, for example, the CPU to which the arbiter 110 is connected, and is performed during the CPU's memory-access time slot.

Although only two CPUs are shown in FIG. 1, persons having ordinary skill in the art will understand that additional CPUs may be added as needed. Moreover, although a separate memory controller is shown for each CPU, the ordinarily skilled artisan will recognize a single memory controller may also be used, as described below.

Referring now to FIG. 2, a memory interface 200 for use with a single memory controller is shown. The memory interface 200 is similar to the memory interface 100 of FIG. 1 in that it connects a first CPU (CPU 1) and a second CPU (CPU2) to a single external memory 202. However, instead of a separate memory controller for each of CPU1 and CPU2, the memory interface 200 includes a single memory controller 204 for both of CPU1 and CPU2. A multiplexer 206 multiplexes each CPU along with the clock signal for that CPU to the memory controller 204. As before, no request-and-grant handshake is needed between the CPUs and the memory controller 204, since the memory controller is effectively dedicated to a single CPU by virtue of the multiplexer 206. An arbiter 208 controls which one of CPUs is multiplexed by the multiplexer 206 to the memory controller 204 on a time slot basis.

To overcome the problem of different clock domains (and potentially reduced bandwidth), the clocks used by the memory controller 204 are selected from the accessing CPUs. Thus, the logic in the memory controller 204 will run synchronously with the accessing CPU, even if CPU1 and CPU2 are running asynchronously relative to one another.

Another difference between FIG. 2 and FIG. 1 is that, in FIG. 2, the area equaling that of one memory controller per CPU is saved. Also, the control functionality of the memory itself (e.g., bank select, etc) may be simpler when there is only one memory controller. On the other hand, use of multiple memory controllers as in FIG. 1 may have an advantage in that it keeps the state of the memory controllers when another CPU is given access.

In some embodiments of the invention, a CPU may be temporarily given a longer time slot than usual, depending on the needs of the various CPUs. For example, where one CPU is performing real-time tasks, that CPU should be guaranteed a fixed allocation of the memory interface memory transactions, while the other CPU allocations are more flexible. However, in instances where the real-time CPU may be experiencing periods of little activity, and these periods coincide with program switching on the other CPUs that require frequent memory access, the other CPUs may be granted a greater than normal share of external memory access. Therefore, an arbiter may be designed to extend the time slots assigned to the other CPUs on a temporary basis when inactivity is detected in the real-time CPU. As another option, instead of time slots, the arbiter may be designed to grant the other CPUs an additional number of memory transactions. Once the temporary allocation has expired, then the arbiter could, for example, revert back to a fixed allocation.

In addition to their memory access control functions, the arbiters described above may also serve a gatekeeper function. For example, in some embodiments, the arbiters may be used to control the manner in which applications running on one of the CPUs, such as CPU2 whose clock is not synchronized with the arbiter, may access the external memory. Specifically, when these applications wish to access data or program code stored in the external memory, the arbiters may require the applications to first authenticate (via CPU2) the data or program code stored in the external memory before granting the applications access to the memory area in which that data or program code has been stored. The authentication may be performed, for example, using any suitable technique known to persons having ordinary skill in the art. In this manner, if the data or program code that was stored in external memory is valid (i.e., it can be authenticated by the applications), the arbiters will make the data or program code available to the applications. Invalid data or program code (i.e., data or program code that cannot be authenticated), however, will not be made available to the application so as to prevent the invalid data or program code from causing any mischief or damage to the system.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

1. A method of granting access to a single external memory from multiple control processors, the method comprising:
defining a first time slot and a second time slot;
granting access to the external memory to a first control processor during the first predefined time slot; and
granting access to the external memory to a second control processor during the second predefined time slot.

2. The method according to claim 1, wherein:
the first control processor accesses the external memory via a first memory controller, the first memory controller having a first clock;
the second control processor accesses the external memory and a second memory controller, the second memory controller having a second clock; and
wherein the first and second clocks of the first and second memory controllers are synchronized with a first clock and a second clock of the first and second control processors, respectively.

3. The method according to claim 2, wherein the step of granting access comprises multiplexing the first and second memory controllers to the external memory during the first and second time slots, respectively.

4. The method according to claim 1, wherein the first and second control processors access the external memory via a single memory controller.

5. The method according to claim 4, wherein the step of granting access comprises multiplexing the first and second control processors to the external memory during the first and second time slots, respectively.

6. The method according to claim 5, wherein the step of granting access further comprises multiplexing a first clock and a second clock of the first and second control processors, respectively, to the external memory during the first and second time slots.

7. The method according to claim 1, further comprising defining areas within the external memory accessible by each of the first and control processors.

8. The method according to claim 7, further comprising:
preventing the first control processor from accessing an area accessible by the second control processor; and
preventing the second control processor from accessing an area accessible by the first control processor.

9. The method according to claim 1, wherein the first and second control processors reside on a single integrated circuit.

10. The method according to claim 9, wherein the first and second control processors have different clock frequencies.

11. The method according to claim 1, further comprising adjusting a length of the first time slot and/or the second time slot based on a memory access activity of the first and/or second control processors, respectively.

12. The method according to claim 2, wherein the external memory has a clock that is synchronized with the clock of whichever memory controller is granted access to the external memory.

13. The method according to claim 1, further comprising requiring the second control processor to authenticate data or program code for which access to the external memory is desired before granting the second control processor access to the external memory.

14. A memory interface for allowing multiple control processors to access a single external memory, comprising:
a first control processor;
a second control processor;
an arbiter inter-operably connected to and synchronized with one of the first and second control processors, wherein the arbiter is configured to:
grant access to the external memory to the first control processor during a first predefined time slot; and
grant access to the external memory to the second control processor during the second predefined time slot.

15. The memory interface according to claim 14, further comprising a first memory controller and a second memory controller, wherein:
the first control processor accesses the external memory via a first memory controller, the first memory controller having a first clock;
the second control processor accesses the external memory and a second memory controller, the second memory controller having a second clock; and
wherein the first and second clocks of the first and second memory controllers are synchronized with a first clock and a second clock of the first and second control processors, respectively.

16. The memory interface according to claim 15, further comprising a multiplexer configured to multiplex the first and second memory controllers to the external memory during the first and second time slots, respectively.

17. The memory interface according to claim 14, further comprising a single memory controller, wherein the first and second control processors are configured to access the external memory via the single memory controller.

18. The memory interface according to claim 17, further comprising a multiplexer configured to multiplex the first and second control processors to the external memory during the first and second time slots, respectively.

19. The memory interface according to claim 17, wherein a multiplexer is further configured to multiplex a first clock and a second clock of the first and second processors, respectively, to the external memory during the first and second time slots.

20. The memory interface according to claim 14, wherein the arbiter is further configured to define areas within the external memory accessible by each control processor.

21. The memory interface according to claim 20, wherein the arbiter is further configured to prevent the first control processor from accessing an area accessible by the second control processor, and vice versa.

22. The memory interface according to claim 14, wherein the first and second control processors reside on a single integrated circuit.

23. The memory interface according to claim 22, wherein the first and second control processors have different clock frequencies.

24. The memory interface according to claim 14, wherein the arbiter is further inferior to adjust a length of the first time slot and/or the second time slot based on a memory access activity of the first and/or second control processors, respectively.

25. The memory interface according to claim 15, wherein the external memory has a clock that is synchronized with the clock of whichever memory controller is granted access to the external memory.

26. The memory interface according to claim 14, further comprising requiring the second control processor to authenticate data or program code which access to the external memory is desired before granting the second control processor access to the external memory.
